(19) United States
(12) Patent Application Publication
(10) Pub. No.: US 2023/0406624 A1
(43) Pub. Date: Dec. 21, 2023

(54) VEHICLE ROTATION DEVICE AND SYSTEM

(71) Applicant: Autostore Technology AS, Nedre Vats (NO)

(72) Inventor: Jørgen Djuve Heggebø, Olen (NO)

(73) Assignee: Autostore Technology AS, Nedre Vats (NO)

(21) Appl. No.: 18/036,041

(22) PCT Filed: Nov. 23, 2021
(86) PCT No.: PCT/EP2021/082640

§ 371 Date: May 9, 2023

(30) Foreign Application Priority Data
Nov. 25, 2020 (NO) 20201294

(51) Int. Cl. B65G 1/04; B61J 1/02

(52) U.S. Cl. CPC B65G 1/0464; B61J 1/02; B65G 1/0478

(57) ABSTRACT

A rotation device rotates an autonomous vehicle operating on a rail system of an automated storage and retrieval system. The system is of the type having a framework structure including a plurality of vertical upright members defining storage columns for storing stacks of storage containers, with the rail system arranged on the framework structure. The rail system includes perpendicular tracks, the intersection of which define a grid having grid cells. The grid cells define openings to the storage columns. The autonomous vehicle is of the type having wheels that travel along the rail system, and which changes direction by alternatively lifting or lowering sets of wheels. One set of wheels is adapted for travel of the vehicle in a first direction, and a second set of wheels is adapted for travel of the vehicle in a second direction, perpendicular to the first direction. The rotation device includes a module adapted for mounting in a grid cell beneath a plane defined by the rail system of the framework structure, and a stationary member affixed to the module. The stationary member is arranged to receive a force, transferred from the container handling vehicle to the stationary member by a mechanical linkage, and to convert the force into a rotation of the vehicle.

### FIELD OF THE INVENTION

The present invention relates to an automated storage and retrieval system for storage and retrieval of containers, in particular to a mechanical device for the rotation of direction of travel of autonomous vehicles operating in such a system.

### BACKGROUND AND PRIOR ART

### Grid Storage Systems Generally

FIG. 1 discloses a typical prior art automated storage and retrieval system 1 with a framework structure 100 and FIGS. 2 and 3 disclose two different prior art container handling vehicles 201,301 suitable for operating on such a system 1.

The framework structure 100 comprises upright members 102, horizontal members 103 and a storage volume comprising storage columns 105 arranged in rows between the upright members 102 and the horizontal members 103. In these storage columns 105 storage containers 106, also known as bins, are stacked one on top of one another to form stacks 107. The members 102, 103 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301 are operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301 in a first direction X across the top of the frame structure 100, and a second set of parallel rails 111 arranged perpendicular to the first set of rails 110 to guide movement of the container handling vehicles 201,301 in a second direction Y which is perpendicular to the first direction X. Containers 106 stored in the columns 105 are accessed by the container handling vehicles through access openings 112 in the rail system 108. The container handling vehicles 201,301 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201,301 comprises a vehicle body 201a,301a, and first and second sets of wheels 201b,301b,201c,301c which enable the lateral movement of the container handling vehicles 201,301 in the X direction and in the Y direction, respectively. In FIGS. 2 and 3 two wheels in each set are fully visible. The first set of wheels 201b,301b is arranged to engage with two adjacent rails of the first set 110 of rails, and the second set of wheels 201c,301c is arranged to engage with two adjacent rails of the second set 111 of rails. At least one of the sets of wheels 201b,301b,201c,301c can be lifted and lowered, so that the first set of wheels 201b,301b and/or the second set of wheels 201c,301c can be engaged with the respective set of rails 110, 111 at any one time.

Each prior art container handling vehicle 201,301 also comprises a lifting device (not shown) for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301 so that the position of the gripping/engaging devices with respect to the vehicle 201,301 can be adjusted in a third direction Z which is orthogonal the first direction X and the second direction Y.

Parts of the gripping device of the container handling vehicle 301 are shown in FIG. 3 indicated with reference number 304. The gripping device of the container handling device 201 is located within the vehicle body 201a in FIG. 2.

Conventionally, and also for the purpose of this application, Z=1 identifies the uppermost layer of storage containers, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=10, Y=2, Z=3. The container handling vehicles 201,301 can be said to travel in layer Z=0, and each storage column 105 can be identified by its X and Y coordinates.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301 comprises a storage compartment or space for receiving and stowing a storage container 106 when transporting the storage container 106 across the rail system 108. The storage space may comprise a cavity arranged centrally within the vehicle body 201a as shown in FIG. 2 and as described in e.g. WO2015/193278A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The central cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the central cavity container handling vehicles 101 may have a footprint which is larger than the lateral area defined by a storage column 105, e.g. as is disclosed in WO2014/090684A1.

The rail system 108 typically comprises rails with grooves in which the wheels of the vehicles run. Alternatively, the rails may comprise upwardly protruding elements, where the wheels of the vehicles comprise flanges to prevent derailing.

These grooves and upwardly protruding elements are collectively known as tracks. Each rail may comprise one track, or each rail may comprise two parallel tracks.

WO2018/146304, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301 can drop off storage containers 106 to be transported to an access or a transfer station, and the second port column 120 may be a dedicated pick-up port column where the container handling vehicles 201,301 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301 is instructed to retrieve the target storage container 106 from its position and transport it to the drop-off port column 119. This operation involves moving the container handling vehicle 201,301 to a location above the storage column 105 in which the target storage container 106 is positioned, retrieving the storage container 106 from the storage column 105 using the container handling vehicle's 201,301 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301 positions the storage container 106 at the desired position. The removed storage containers 106 may then be lowered back into the storage column 105, or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201,301 so that a desired storage container 106 can be delivered to the desired location at the desired time without the container handling vehicles 201,301 colliding with each other, the automated storage and retrieval system 1 comprises a control system 500 which typically is computerized and which typically comprises a database for keeping track of the storage containers 106.

### Direction of Travel of Container Handling Vehicles

As described above, container handling vehicles 201, 301 are able to change direction from travelling in the X direction to travelling in the Y direction by raising and lowering one of two sets of wheels that engage the rail system 108 of the framework structure 100. This applies as well to other types of vehicles operating on the rail system of the framework structure, such as service vehicles or other specialized vehicles performing various functions. While the direction of travel of the vehicle—as a whole—changes from the X to the Y direction, the orientation of the vehicle body remains unchanged. Once positioned on the rail system, the vehicle body will maintain its orientation regardless of the number of direction changes executed.

There are situations, however, in which it is desirable for the vehicle body to change its orientation with respect to the framework structure. This is particularly true with respect to vehicles 201 of the type having a cantilevered lifting part extending beyond the vehicle body. The extended part may become an obstacle, preventing the vehicle body from direct access to parts of the storage system in the direction of the lifting part. In some instances, for example, there may be charging ports or other structures on the vehicle body that must be brought adjacent to another structure, which is prevented by the lifting part. It may also be desirable for a vehicle to position itself directly adjacent to another vehicle in a specific orientation. There are also situations where it is advantageous to alter the orientation of the vehicle body of a more symmetrical vehicle 301, of the type without a cantilevered lifting part, or any other type of vehicle operating on the framework structure. There are also possible configurations of an automated storage and retrieval system where vehicles travel along tracks at physical locations other than at the top level of the framework structure. For example, dedicated delivery vehicles may operate along a rail system at a lower level of the automated storage system on a rail system. It may be desirable to rotate the orientation of such vehicles as well.

### SUMMARY OF THE INVENTION

The present invention is set forth and characterized in the independent claims, while the dependent claims describe other characteristics of the invention.

In one aspect, the invention is related to a system and device for rotating a vehicle that travels along a rail system of an automated storage and retrieval system, of the type described in the background section of this application, in which the power for rotating the vehicle is supplied by the vehicle itself. While the invention will be described in connection with container handling vehicles operating at an upper level of the framework structure of an automated storage and retrieval system, it should be understood that the scope of the invention may in other aspects include other types of vehicles such as service vehicles and other specialty vehicles operating on a top level rail system, as well as vehicles operating on a rail system at other physical locations of the system, such as at a lower level.

In one aspect, the invention relates to a device and a system employing the device for rotating an autonomous vehicle operating, for example but not limited to a container handling vehicle, on a rail system, for example at an upper level of an automated storage and retrieval system, of the type having a framework structure comprising a plurality of vertical upright members defining storage columns for storing stacks of storage containers, with a rail system arranged on an upper level of the framework structure, the rail system comprising perpendicular tracks, the intersection of which define a grid having grid cells, the grid cells defining openings to the storage columns, and where the container handling vehicle is of the type having wheels that travel along the rail system, and which change direction by alternatively lifting or lowering sets of wheels, one set of wheels adapted for travel of the vehicle in a first direction, and a second set of wheels adapted for travel of the vehicle in a second direction, perpendicular to the first direction, wherein the system comprises:
a. rotation device comprising a module, the module according to one aspect having a front wall, sides, a back wall and a bottom, the module adapted for mounting in a grid cell beneath a plane defined by the rail system of the framework structure,
b. a stationary member affixed to the bottom of the module,
c. wherein the vehicle and/or the module comprises a mechanical linkage arranged to transfer a force from the vehicle to the stationary member, whereby the force is converted into a rotation of the vehicle.

In one aspect, the rotation system of the invention comprises a rotation device in the form of a module that may be inserted into a grid cell of the framework structure of the automated storage and retrieval system. The module comprises a stationary member, with respect to which the vehicle rotates, via a rotational or translational force from the vehicle being transferred to the stationary member via a mechanical linkage. In one aspect the stationary member is a circular member.

In one aspect, the module has sides and a bottom, and the stationary member is a stationary gear affixed to the bottom of the module, hereafter referred to as a module gear. A mechanical linkage transfers a rotational force from the vehicle to the module gear in order to rotate the vehicle. In one aspect, the rotational force is the rotation of the wheels of the vehicle that is transferred by a mechanical linkage in order to rotate the vehicle. In another aspect, the rotational force is the rotation of a gear of the vehicle, for example a worm gear. In another aspect, the rotational force may be the rotation of a rotatable plate.

In one embodiment, the rotation device comprises a rotatable turntable, the outer periphery of which comprises track segments that replace the rail sections surrounding the grid cell in which the module is installed. The track segments of the module are contiguous with the rail system of the framework structure when the turntable is in a non-rotated, aligned state, thereby allowing vehicles to traverse the turntable in the normal fashion. The turntable is rotatably connected to a center axle of the module gear by an arm or spindle. The arm is rotatable and comprises a turntable gear that engages the module gear, for example by having an axis of rotation perpendicular to the axis of rotation of the stationary gear . Rotation of the arm thus causes the turntable gear to travel circumferentially about the module gear. A mechanical linkage transfers a rotational force from the vehicle to the arm in order to rotate the turntable gear, which causes the turntable, upon which rests the vehicle, to rotate about the module gear. In one aspect, the mechanical linkage is one or more rollers integrated into the track segments of the turntable, connected to the arm by a drive belt, the rollers being operated by the rotation of the wheels of the vehicle.

In a second embodiment, the module does not comprise a rotatable turntable. In this embodiment, the module may either comprise its own track segments that contiguously replace the rail sections about the grid cell, or the module may merely be arranged in connection with the existing rail system of a grid cell, for example by being mounted underneath the existing rail system surrounding a grid cell. According to this second embodiment, the stationary member is again a stationary module gear. In this embodiment, the module gear has a center portion upon which a lower surface of the vehicle body may rest, for example via the vehicle raising its drive wheels and lowering the body of the vehicle onto the center portion of the module gear. A gear, for example but not limited to, a worm gear on the underside of the vehicle is arranged to engage teeth of the module gear and rotate the vehicle, with its lifted wheels, about the center portion of module gear. After the rotation is complete, the wheels are lowered into engagement with the rail system of the framework structure, lifting the vehicle off of the module gear. The underside of the vehicle may advantageously comprise a guide pin that cooperates with a recess in the center portion of the module gear to ensure proper alignment of the vehicle with the module gear during rotation.

In a third embodiment, the stationary member is a stationary post arranged in the bottom of the module. As with the second embodiment, the vehicle may lower itself to rest upon the stationary post by raising its wheels. In this embodiment, a rotatable plate under the vehicle rests upon the post. The rotatable plate is then caused to rotate, which causes the vehicle, with its lifted wheels, to rotate about the stationary post. The rotatable plate may be powered by a mechanical drive, a separate electric motor, a linkage to the drive wheels or other known means.

The rotation device of the invention, being in the form of a module, has the advantage that it can be inserted with minimal effort into almost any cell of the framework structure. According to one aspect, the module is dimensioned to occupy the cross sectional area of a grid cell. Since the rotation device is powered by the vehicle itself, there is no need to arrange power cables leading to the module, or use separate motors for powering the device. This makes the present invention a very flexible and easy to install solution for changing the orientation of container handling vehicles with respect to the framework structure, in the various situations where such rotation is advantageous.

According to one aspect, the rotating a vehicle is initiated by the control system of the automated storage and retrieval system sending a command to a vehicle to position itself above the rotation device, and a command to engage the internal force-delivering mechanism of the vehicle that is connected to the rotation device, for example to rotate the wheels resting on the rollers of one embodiment of the device, to engage the worm gear from another embodiment of the device or to rotate the rotatable plate from another embodiment of the deice, as well as commends to lift the wheels of the vehicle where necessary.

It is to be understood that the mechanical linkages and gears shown in the various embodiments may be replaced by alternatives within the scope of the invention. For example, a drive belt may be a drive chain, the worm gear underneath the vehicle may be a vertically oriented standard gear arranged to engage the module gear, etc.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3 is a perspective view of a prior art container handling vehicle having a cantilever for carrying storage containers underneath.

FIG. 4 is a perspective view of an embodiment of the rotation device of the invention.

FIG. 5 is a perspective view of the device from FIG. 4 having rotated approximately 90 degrees.

FIG. 6 is an exploded view of the rotation device of FIG. 4.

FIG. 7 is an assembled view of FIG. 6.

FIG. 8 is a perspective view of a rotation device module, showing a protective plate covering the gears.

FIG. 9 is an overhead view FIG. 8, showing the track system of the framework structure and installed module.

FIG. 10 is a cut away perspective view showing the wheels of the vehicle engaging rollers of the rotating device of FIG. 4.

FIG. 11 is a cut away perspective view of the device from FIG. 10 having rotated approximately 45 degrees.

FIG. 12 is a perspective view of a vehicle with cantilevered lifting part positioned on the rotation device of FIG. 4.

FIG. 13 is a perspective view of the rotation device from FIG. 12 having rotated approximately 45 degrees.

FIG. 14 is a perspective view of details of a second embodiment of the invention, showing stationary module gear.

FIG. 15 is a top view of FIG. 14.

FIG. 16 is a side elevational view of FIG. 14.

FIG. 17 is a view from underneath of a vehicle used in connection with the second embodiment, showing a worm gear.

FIG. 18 is a detailed perspective view from FIG. 17.

FIG. 19 is a cut away view showing the vehicle lifted such that the worm gear is out of engagement with the module gear.

FIG. 20 is a side elevational view of the vehicle from FIG. 19 immediately prior to engagement of its worm gear with the module gear of the second embodiment.

FIG. 21 is a side elevational view from FIG. 20, showing the vehicle lowered such that its worm gear is in engagement with the module gear of the second embodiment.

FIG. 22 is a cut away view showing the worm gear of the vehicle in engagement with the module gear of the second embodiment.

FIG. 23 is a perspective view of a vehicle positioned on top of the second embodiment, and rotated approximately 45 degrees with its wheels lifted.

FIG. 24 is a view of a third embodiment of the invention, showing a rotatable plate underneath the vehicle.

FIG. 25 is a view showing the vehicle of FIG. 24 resting on a post arranged in the bottom of a module.

FIG. 26 is a side view of FIG. 25.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

The present invention is utilized in connection with an automated storage and retrieval system of the type described in the background section of this application.

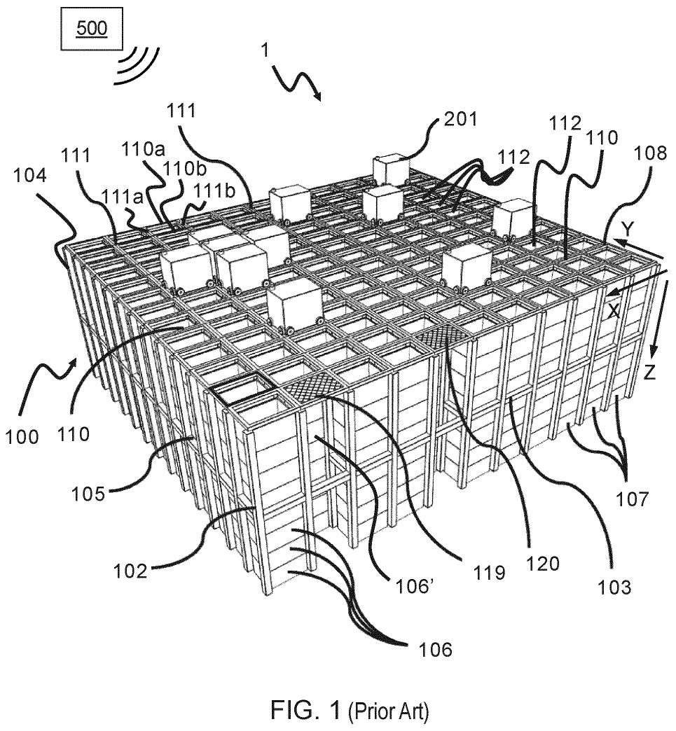

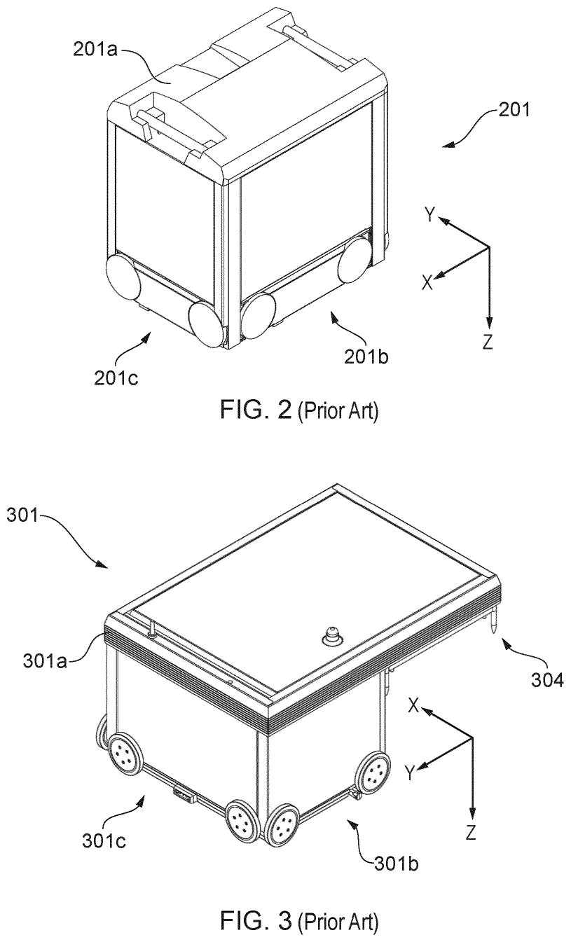

The framework structure 100 of the automated storage and retrieval system 1 is constructed in accordance with the prior art framework structure 100 described above in connection with FIGS. 1-3, i.e. a number of upright members 102 and a number of horizontal members 103, which are supported by the upright members 102, and further that the framework structure 100 comprises a first, upper rail system 108 in the X direction and Y direction.

The framework structure 100 further comprises storage compartments in the form of storage columns 105 provided between the members 102, 103, where storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

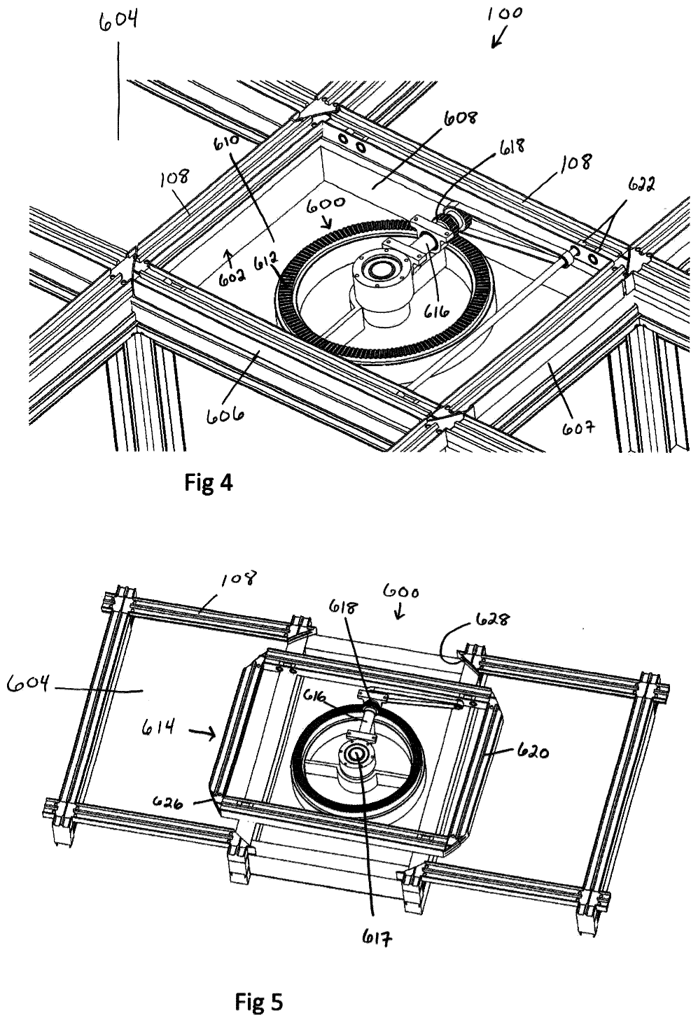

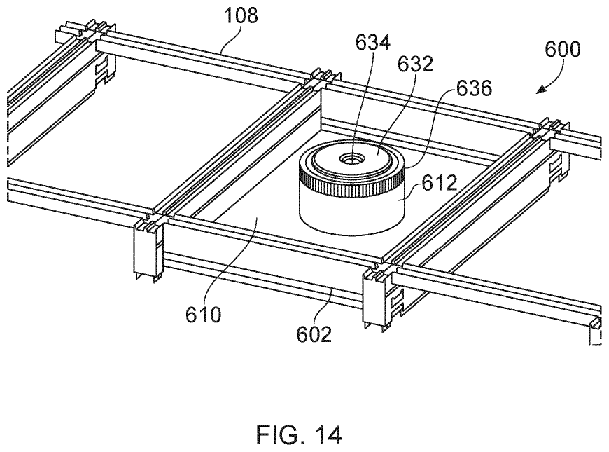

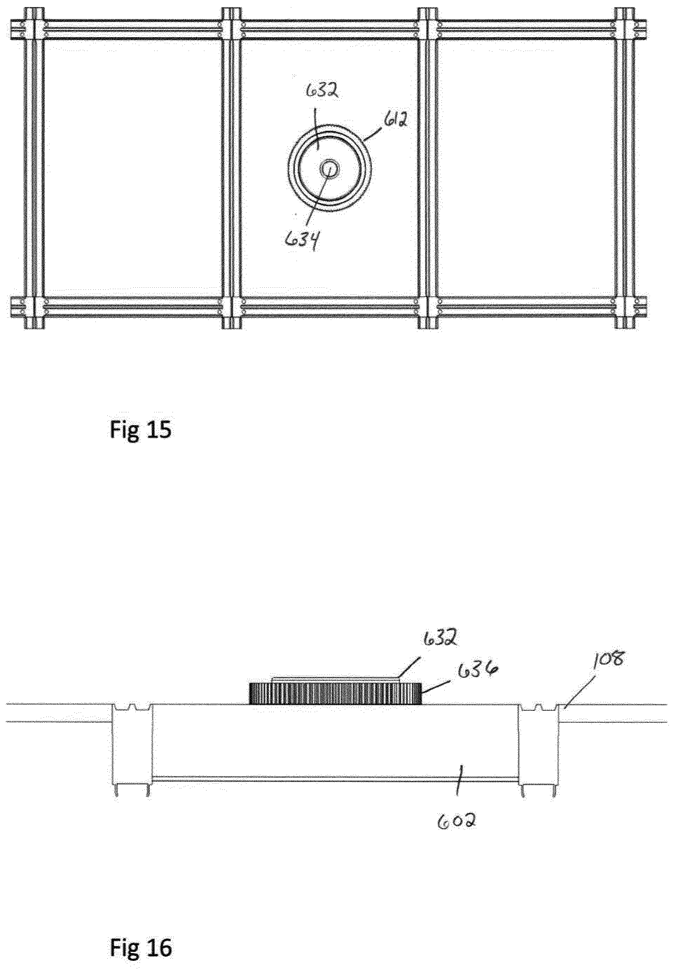

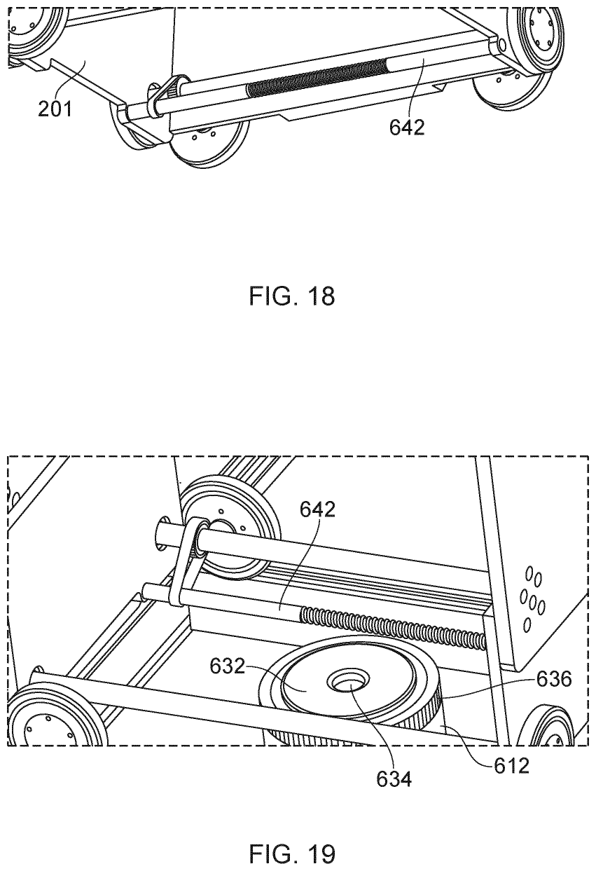

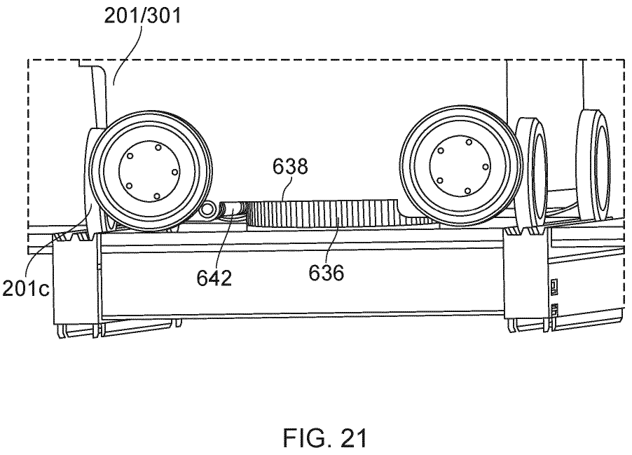

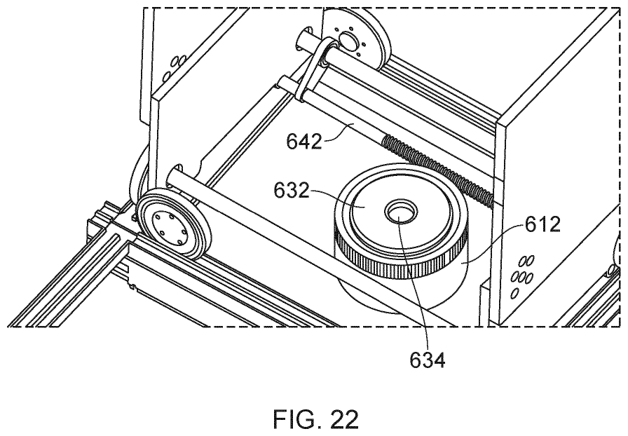

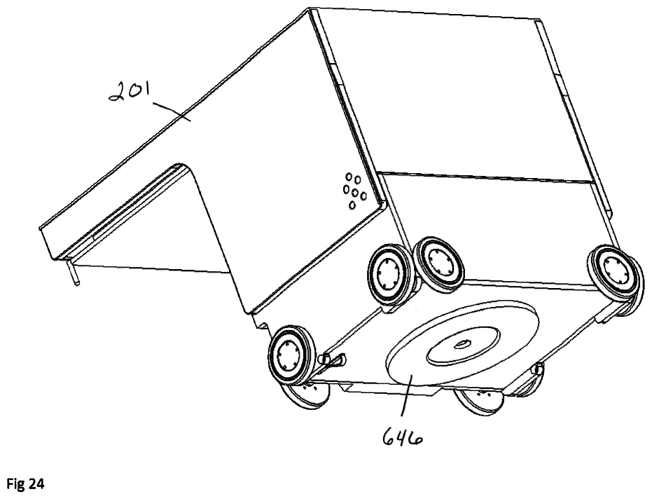

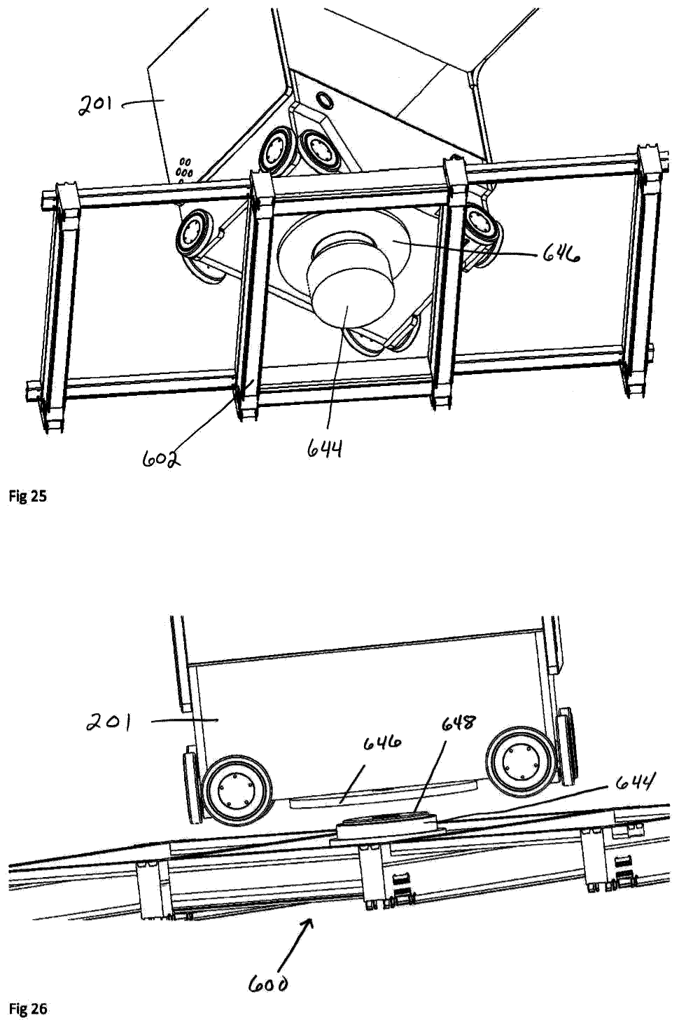

Various aspects of a vehicle rotation device 600 according to preferred embodiments of the invention will now be discussed in more detail with reference to FIGS. 4-13, which illustrate a first embodiment of the invention, FIGS. 14-23 which illustrate a second embodiment of the invention, and FIG. 24 which illustrates a third embodiment of the invention.

In the preceding description, various aspects of the container handling vehicle 201/301 and the automated storage and retrieval system according to the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

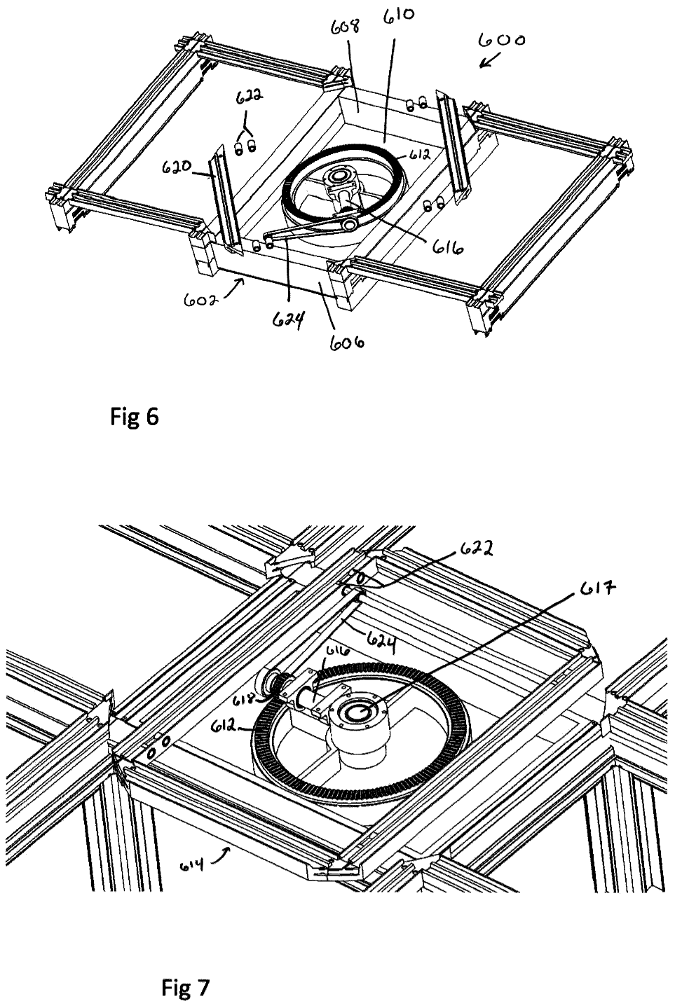

As shown in FIG. 4, according to a first embodiment the vehicle rotation device 600 of the present invention is in the form of a module 602 arranged to be inserted into and occupy a grid cell 604 of framework structure 100. FIG. 4 shows device 600 in a non-rotated state, while FIG. 5 shows the rotation device 600 in a rotated state, having rotated approximately 90 degrees.

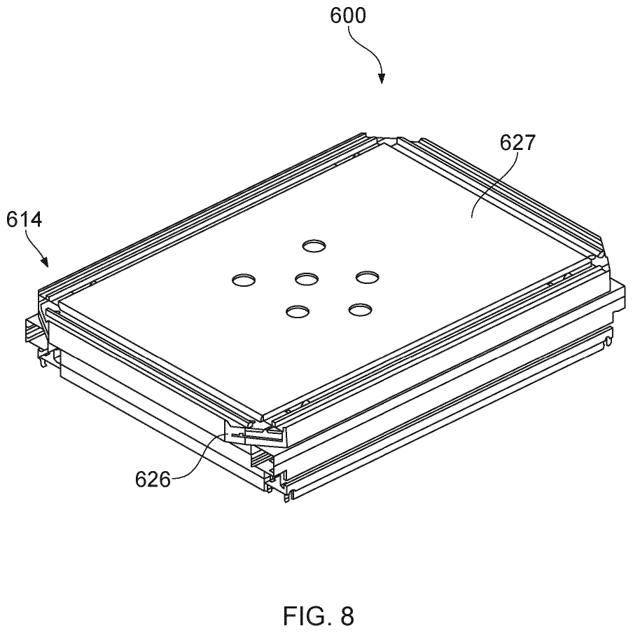

As shown in FIGS. 6-9, the rotation device 600 comprises module 602. Module 602 comprises a front wall 606, sides 607, a back wall 608 and a bottom 610. Mounted on bottom 610 is a stationary gear 612, referred to hereafter as a “module gear”. It should be understood that the particular shape and arrangement of the module gear is exemplary, and that one skilled in the art will recognize that various types of gears can be employed. A rotatable turntable 614 is movably connected to module gear 612 via a rotatable extension arm or spindle 616 connected to a center axle 617, as shown in FIG. 5. The rotatable extension arm 616 and center axle 617 have axes of rotation arranged at 90 degrees to each other. A turntable gear 618 is affixed to rotatable extension arm 616 and arranged to travel about the circumference of module gear 612 as extension arm 616 rotates.

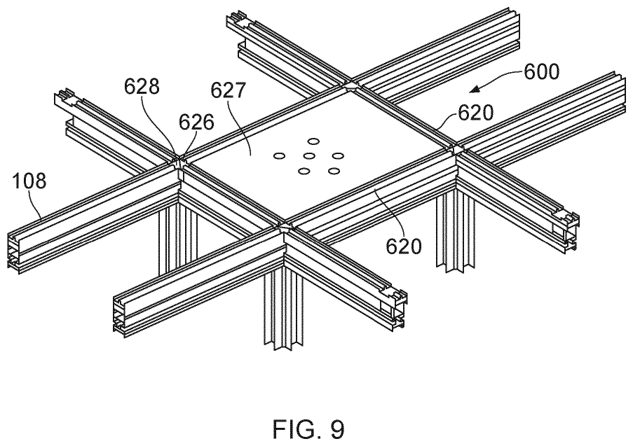

Turntable 614 comprises a plurality of track sections 620, arranged to be coextensive with the periphery of cell 604, and to provide contiguous communication with rail system 108 of framework 100 when turntable 614 is in a non-rotated state (aligned state), as shown in FIGS. 4 and 9.

Integrated in track sections 620 is one or more rollers 622, connected to rotatable extension arm 616 by a drive belt 624. Rotation of the one or more rollers 622 thus cause turntable gear 618 to travel circumferentially about module gear 612, rotating the turntable with respect to module gear 612.

As shown in FIG. 5, turntable 614 has arcuate corners 626 that are angled at substantially 45 degrees, and which cooperate with arcuate angled end parts 628.

As shown in FIG. 8, turntable 614 of rotation device 600 may comprise a cover plate 627 covering the inner components of the module.

As shown in FIG. 9, arcuate corners 626 and arcuate end parts 628 align to permit vehicles to traverse the track sections of the rotation device when the device is in a non-rotated state.

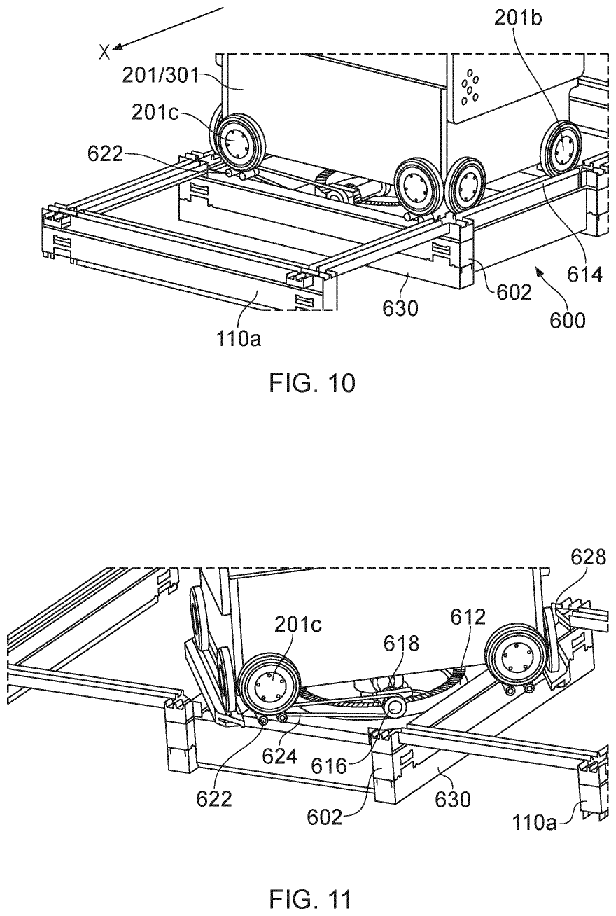

FIG. 10 shows a container handling vehicle 201 at rest on the rotation device 600. Fig also illustrates the manner in which module 602 is inserted into grid cell 604. In grid cell 604, parallel rails 110a are removed, and replaced by module rails 630. Rail system 108 is cut or removed at grid cell 604, such that the rail system includes arcuate angled end parts 628. Module 602 may then be placed upon module rails 630 and fixed in place in a manner known in the art.

As shown in FIGS. 10 and 11, vehicle 201/301 is driven onto turntable 614 such that one or more of wheels 201c rests upon rollers 622. For example, vehicle 201/301 may be driven onto turntable 614 in direction X as shown in FIG. 10 by wheels 201b. Wheels 201b may then be raised in order to lower wheels 201c onto rollers 622. Alternatively, vehicle 201 may be driven in a direction Y, perpendicular to direction X, by wheels 201c directly onto rollers 622.

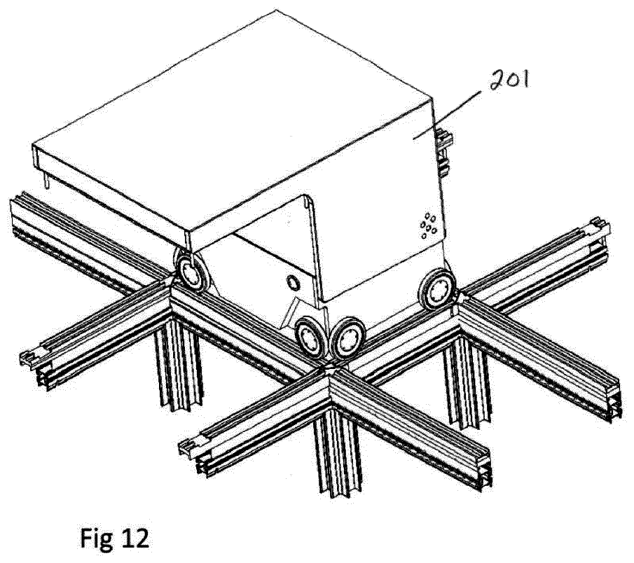

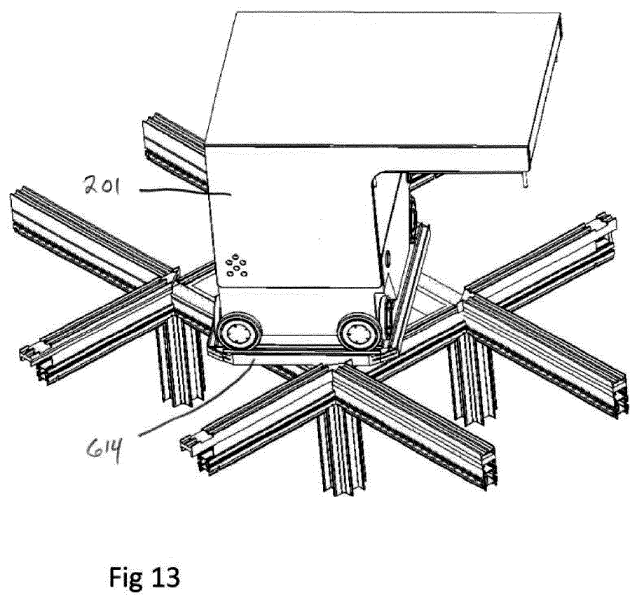

Once wheels 201c are in position on rollers 622 as shown in FIGS. 10 and 12, the wheels 201c are caused to rotate through torque provided by drive motors in the vehicles 201/301, which in turn causes drive belt 624 to rotate extension arm 616 about an axis of the center axle 617. As extension arm 616 rotates, turntable gear 618 travels about module gear 612, rotating turntable 614 and vehicle 201/301, as shown in FIGS. 11 and 13.

A second embodiment of the invention is illustrated in FIGS. 14-23. As shown in FIG. 14, module 602 comprises a stationary gear 612 mounted on bottom 610. In this embodiment there is no rotatable turntable. Rather, the rail system 108 remains intact about the grid cell in which the rotation device is inserted. Alternatively, module 602 may comprise its own track segments which replace the portions of rail system 108 surrounding the grid cell.

Module gear 612 has a center section 632. In one aspect, center section 632 has a recess 634. In one aspect, module gear 612 may protrude vertically above a horizontal plane defined by an upper surface of rail system 108, with center section 632 protruding vertically higher than module gear teeth 636.

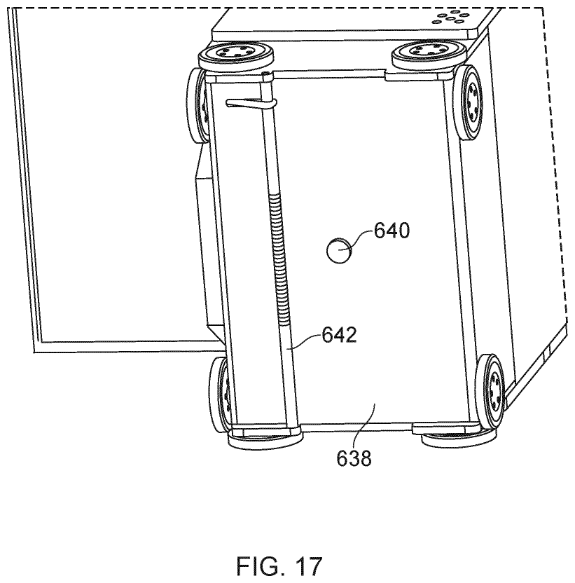

According to this second embodiment, the container handling vehicle body has an underside 638. In one aspect, a guide pin 640 is arranged on underside 638, as shown in FIG. 17. A gear 642 is located below vehicle body underside 638, arranged to engage stationary gear 612 to apply a thrust that is reacted by the stationary gear in order to rotate the vehicle. In one embodiment gear 642 is a worm gear, but one skilled in the art will recognize that other types of gears can be employed. Gear 642 may be caused to rotate by the motors for the drive wheels of the vehicle or by other means.

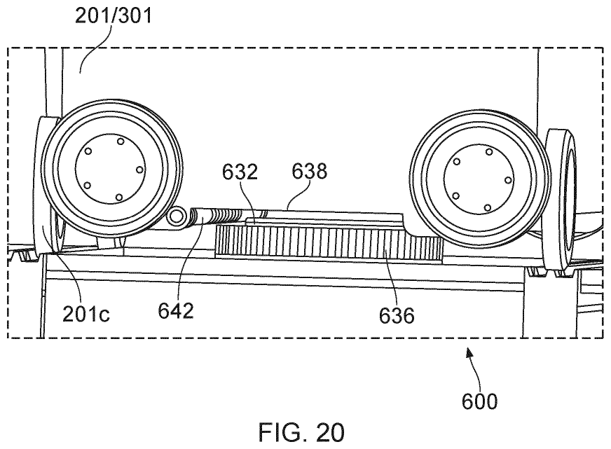

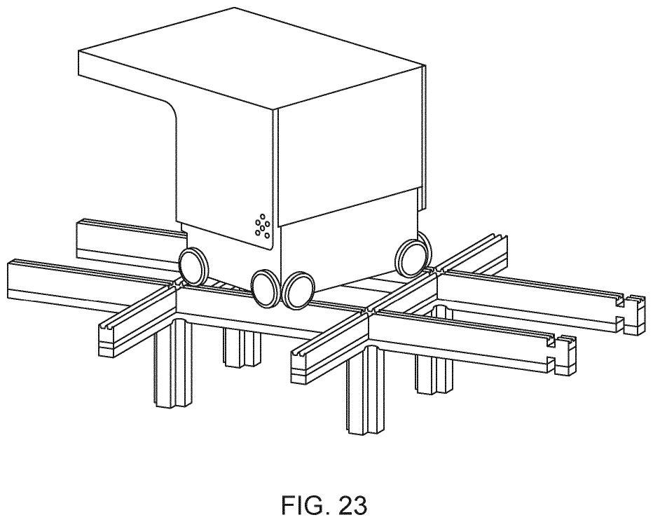

FIGS. 20-23 illustrate the operation of the second embodiment. Vehicle 201/301 is driven onto rotation device 600. Wheels 201c are lifted, such that vehicle underside comes to rest upon center section 632 of module gear 612. As can be appreciated, a guide pin 640 can insert into recess 634 to align the vehicle with the module gear. Wheels 201c are then further lifted, such that vehicle 201/301 rests fully upon module gear, with worm gear 642 engaged with module gear teeth 636. Rotation of the worm gear 642 will thereby cause vehicle 201/301 to rotate about module gear 612. After the rotation is complete, the wheels of the vehicle are lowered into contact with the rail system, as shown in FIG. 23.

FIG. 24 illustrates a third embodiment of the invention. Similar to the second embodiment, the third embodiment does not comprise a rotatable turntable. In the third embodiment, module 602 comprises a stationary post 644 rather than a module gear 612. In this embodiment, vehicle 201/301 comprises a rotatable plate 646. As in the case of the second embodiment, the third embodiment operates by the vehicle driving onto the rotation device, and raising its wheels such that the vehicle comes to rest upon post 644, with rotatable plate 646 resting on an upper surface 648 of post 644. By rotating the rotatable plate, the vehicle rotates about post 644. Rotatable plate 646 may be caused to rotate by a mechanical linkage to the vehicles drive wheels, by its own motor, or by other means known in the art.

### LIST OF REFERENCE NUMBERS

### Prior Art (FIGS. 1-4)

1 Prior art automated storage and retrieval system
100 Framework structure
102 Upright members of framework structure
103 Horizontal members of framework structure
104 Storage grid
105 Storage column
106 Storage container
106′ Particular position of storage container
107 Stack
108 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
201 Prior art storage container vehicle
201a Vehicle body of the storage container vehicle 201
201b Drive means/wheel arrangement, first direction (X)
201c Drive means/wheel arrangement, second direction (Y)
301 Prior art cantilever storage container vehicle
301a Vehicle body of the storage container vehicle 301
301b Drive means in first direction (X)
301c Drive means in second direction (Y)
304 Gripping device
500 Control system
X First direction
Y Second direction
Z Third direction

### Present Invention

600 Vehicle rotation device
602 Module
604 Grid cell
606 front wall
607 sides
608 back wall
610 Bottom
612 Module gear
614 turntable
616 extension arm
617 center axle
618 turntable gear
620 track sections
622 rollers
624 drive belt
626 corners
627 cover plate
628 end parts
630 module rails
632 Center section
634 recess
636 Module gear teeth
638 vehicle body underside
640 Guide pin
642 worm gear
644 post
646 rotatable plate
648 Upper post surface

1. A rotation device for rotating an autonomous vehicle operating on a rail system of an automated storage and retrieval system, of the type having a framework structure comprising a plurality of vertical upright members defining storage columns for storing stacks of storage containers, with the rail system arranged on the framework structure, the rail system comprising perpendicular tracks, the intersection of which define a grid having grid cells, the grid cells defining openings to the storage columns, and where the autonomous vehicle is of the type having wheels that travel along the rail system, and which changes direction by alternatively lifting or lowering sets of wheels, one set of wheels adapted for travel of the vehicle in a first direction, and a second set of wheels adapted for travel of the vehicle in a second direction, perpendicular to the first direction, wherein the rotation device comprises:
a. a module adapted for mounting in a grid cell beneath a plane defined by the rail system of the framework structure,
b. a stationary member affixed to the module,
c. wherein the stationary member is arranged to receive a force, transferred from the container handling vehicle to the stationary member by a mechanical linkage, and to convert the force into a rotation of the vehicle.

2. The rotation device according to claim 1, wherein the stationary member is a circular member.

3. The rotation device according to claim 1, wherein the stationary member is a stationary gear having gear teeth.

4. The rotation device according to claim 1, wherein the stationary member is a post.

5. The rotation device according to claim 1, wherein the device further comprises a turntable, rotatably connected to the stationary member, the turntable comprising track sections around its periphery, the track sections being in contiguous communication with the rail system of the framework structure when the turntable is in a non-rotated, aligned state, and wherein the device comprises means to convert a rotational force from the wheels of a container handling vehicle at rest on the turntable to a rotational force to rotate the turntable.

6. The rotation device according to claim 5, wherein the turntable is connected to the stationary member via a rotatable extension arm or spindle, the arm comprising a rotatable turntable gear arranged to travel circumferentially around the stationary gear when the rotatable turntable gear is rotated, wherein the turntable further comprising one or more rollers arranged in the track segments, and connected by a drive belt to the rotatable extension arm, such that rotation of the wheels of the container handling vehicle is converted into rotation of the rotatable extension arm, thereby rotating the turntable.

7. The rotation device according to claim 3, wherein the stationary gear has a center section adapted for an underside of the container handling vehicle to rest upon when the wheels of the container handling vehicle are lifted, thereby supporting the container handling vehicle above the plane of the rail system, the teeth of the stationary gear being adapted to engage a gear on an underside of the container handling vehicle and convert rotation of the gear into rotation of the container handling vehicle.

8. The rotation device according to claim 7, wherein gear is a worm gear.

9. The rotation device according to claim 4, wherein the post has an upper surface adapted for a rotatable plate arranged on an underside of the container handling vehicle to rest upon when the wheels of the container handling vehicle are lifted, thereby supporting the container handling vehicle above the plane of the rail system, whereby rotation of the rotatable plate is converted into rotation of the container handling vehicle.

10. A system for rotating an autonomous vehicle operating on a rail system of an automated storage and retrieval system, of the type having a framework structure comprising a plurality of vertical upright members defining storage columns for storing stacks of storage containers, with the rail system arranged on the framework structure, the rail system comprising perpendicular tracks, the intersection of which define a grid having grid cells, the grid cells defining openings to the storage columns, and where the vehicle is of the type having wheels that travel along the rail system, and which changes direction by alternatively lifting or lowering sets of wheels, one set of wheels adapted for travel of the vehicle in a first direction, and a second set of wheels adapted for travel of the container handling vehicle in a second direction, perpendicular to the first direction, wherein the system comprises:
a. rotation device comprising a module adapted for mounting in a grid cell beneath a plane defined by the rail system of the framework structure,
b. a stationary member affixed to the bottom of the module,
c. wherein the vehicle and/or the module comprises a mechanical linkage arranged to transfer a force from the vehicle to the stationary member, whereby the force is converted into a rotation of the vehicle
d. a control system arranged to issue commands to the vehicle to initiate and complete a rotation.

11. The system according to claim 10, wherein the vehicle is a container handling vehicle.

12. The system according to claim 8, wherein the stationary member is a stationary gear having gear teeth.

13. The system according to claim 8, wherein the stationary member is a post.

14. The system according to claim 10, wherein the device further comprises a turntable, rotatably connected to the stationary member, the turntable comprising track sections around its periphery, the track sections being in contiguous communication with the rail system of the framework structure when the turntable is in a non-rotated, aligned state, and wherein the rotation device comprises means to convert a rotational force from the wheels of a vehicle at rest on the turntable to a rotational force to rotate the turntable with the vehicle.

15. The system according to claim 12, wherein the turntable is connected to the stationary gear via a rotatable extension arm or spindle, the arm comprising a rotatable gear arranged to travel circumferentially around the stationary gear when the rotatable gear is rotated, the turntable further comprising one or more rollers arranged in the track sections, and connected by a drive belt to the rotatable arm, such that rotation of the wheels of the vehicle is converted into rotation of the rotatable arm, thereby rotating the turntable with the vehicle.

16. The system according to claim 10, wherein the stationary gear has center section adapted for an underside of the vehicle to rest upon when the wheels of the vehicle are lifted, thereby supporting the vehicle above the plane of the rail system, the teeth of the gear adapted to engage a gear on the underside of the vehicle and convert rotation of the gear into rotation of the vehicle about the stationary gear.

17. The system according to claim 16, wherein the underside of the container handling vehicle comprises a guide pin arrange to insert in a recess of the center section.

18. The rotation device according to claim 13, wherein the stationary post has an upper surface adapted for a rotatable plate arranged on an underside of the vehicle to rest upon when the wheels of the vehicle are lifted, thereby supporting the vehicle above the plane of the rail system, whereby rotation of the rotatable plate is converted into rotation of the vehicle.
